(19) United States
(12) Patent Application Publication
(10) Pub. No.: US 2015/0145791 A1
(43) Pub. Date: May 28, 2015

(54) TOUCH SENSOR MODULE AND MANUFACTURING METHOD THEREOF

(71) Applicant: SAMSUNG ELECTRO-MECHANICS CO., LTD., Gyeonggi-Do (KR)

(72) Inventors: Young Jae KIM, Gyeonggi-Do (KR); Sung Kwon WI, Gyeonggi-Do (KR); Ha Yoon SONG, Gyeonggi-Do (KR); Ho Joon PARK, Gyeonggi-Do (KR)

(73) Assignee: SAMSUNG ELECTRO-MECHANICS CO., LTD., Gyeonggi-Do (KR)

(21) Appl. No.: 14/506,068

(22) Filed: Oct. 3, 2014

(30) Foreign Application Priority Data
Nov. 22, 2013 (KR) 10-2013-0142875

(51) Int. Cl. G06F 3/041; B32B 37/12; B32B 38/00; B32B 37/24

(52) U.S. Cl. CPC G06F 3/0412; B32B 37/24; B32B 37/12; B32B 38/0012; B32B 2037/243; B32B 2457/00; G06F 2203/04103
USPC 345/173; 156/60

(57) ABSTRACT

Embodiments of the invention provide a touch sensor module, including a base substrate having an electrode pattern formed thereon and an electrode pad transferring an electrical signal of the electrode pattern to the outside, a passivation layer coating surfaces of the electrode patterns, and a flexible cable having a terminal portion formed to correspond to the electrode pad and including an adhesive layer disposed between the electrode pad and the terminal portion. According to at least one embodiment, the passivation layer is formed to not be overlapped with the terminal portion.

### CROSS REFERENCE TO RELATED APPLICATION

This application claims the benefit of and priority under 35 U.S.C. §119 to Korean Patent Application No. KR 10-2013-0142875, entitled “TOUCH SENSOR MODULE AND MANUFACTURING METHOD THEREOF,” filed on Nov. 22, 2013, which is hereby incorporated by reference in its entirety into this application.

### BACKGROUND

1. Field of the Invention

The present invention relates to a touch sensor module and a manufacturing method thereof.

2. Description of the Related Art

In accordance with the growth of computers using a digital technology, devices assisting the computers have also been developed, and personal computers, portable transmitters, other personal information processors, for example, execute processing of text and graphics using a variety of input devices such as a keyboard and a mouse.

In accordance with the rapid advancement of an information-oriented society, the use of computers has gradually been widened; however, it is difficult to efficiently operate products using only the keyboard and the mouse currently serving as an input device. Therefore, the necessity for a device that is simple, has minimum malfunction, and is capable of easily inputting information has been increased.

In addition, current techniques for input devices have progressed toward techniques related to high reliability, durability, innovation, designing and processing beyond the level of satisfying general functions. To this end, a touch sensor has been developed as an input device capable of inputting information, such as text or graphics, as non-limiting examples.

This touch sensor is mounted on a display surface of a display, such as an electronic organizer, a flat panel display device including a liquid crystal display (LCD) device, a plasma display panel (PDP), an electroluminescence (El) element, or a cathode ray tube (CRT), as non-limiting examples, to thereby be used to allow a user to select desired information while viewing the display.

In addition, the touch sensor is classified into a resistive type, a capacitive type, an electromagnetic type, a surface acoustic wave (SAW) type, and an infrared type.

These various types of touch sensors are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch sensor and the capacitive type touch sensor have been prominently used in a wide range of fields.

Korean Patent Laid-Opened Publication No. 10-2011-0107590 describes a conventional touch sensor.

Korean Patent Laid-Opened Publication No. 10-2011-0107590 describes a structure of a conventional touch sensor. The touch sensor, according to this reference, is configured to include a substrate, electrodes formed on the substrate, electrode wirings extended from the electrodes and gathered on one end of the substrate, and a controller connected to the electrode wirings through a flexible printed circuit board hereinafter, referred to as a “flexible cable”).

According to this reference, the flexible cable serves to transfer signals generated in the electrode to the controlling unit through the electrode wirings. In this case, the flexible cable is electrically connected to the electrode wirings to transfer the signal. However, the flexible cable and the electrode wirings have frequently a poor connection caused by moisture infiltration and reliability of a product may be decreased by the frequently poor connection.

### SUMMARY

Accordingly, embodiments of the invention have been made to provide a touch sensor module capable of preventing disconnection and poor contact between an electrode pad and a flexible cable due to moisture by forming a passivation layer and the flexible cable so as not to be overlapped with each other.

According to an embodiment of the invention, there is provided a touch sensor module, including a base substrate having an electrode pattern formed thereon and including an electrode pad transferring an electrical signal of the electrode pattern to the outside, a passivation layer coating surfaces of the electrode patterns, and a flexible cable having a terminal portion formed to correspond to the electrode pad and including an adhesive layer disposed between the electrode pad and the terminal portion. According to at least one embodiment, the passivation layer is formed to not be overlapped with the terminal portion.

According to at least one embodiment, the touch sensor module further includes a PI portion formed to be protruded in one side direction of the flexible cable to thereby prevent moisture and prevent the adhesive layer from being delaminated.

According to at least one embodiment, a portion of an adhesive solution of the adhesive layer is moved by pressing the flexible cable and is stacked on the passivation layer.

According to at least one embodiment, the adhesive layer is made of one of an anisotropic conductive film (ACF) and an anisotropic conductive adhesive (ACA).

According to at least one embodiment, a portion of conductive balls in the adhesive layer is moved by pressing the flexible cable and is stacked on the passivation layer.

According to at least one embodiment, the PI portion has a protruded length formed to be longer than a diameter of the conductive ball.

According to at least one embodiment, the protruded length of the PI portion is formed to be 500 μm or more taking into account assembly tolerance.

According to at least one embodiment, the PI portion has a thickness formed to be smaller than a thickness of the flexible cable.

According to another embodiment of the invention, there is provided a manufacturing method of a touch sensor module, the method including the steps of a) preparing a base substrate having electrode patterns and an electrode pad formed thereon, b) forming a passivation layer coating up to one side end portion of the electrode pattern arid the electrode pad, and c) connecting a flexible cable to the electrode pad using an adhesive layer.

According to at least one embodiment, in step c) a PI portion protruded in one side direction of the flexible cable to thereby prevent moisture and prevent the adhesive layer from being delaminated is formed.

According to at least one embodiment, the adhesive layer is made of an anisotropic conductive film (ACF) or an anisotropic conductive adhesive (ACA).

According to at least one embodiment, the PI portion has a protruded length formed to be longer than a diameter of the conductive ball of the adhesive layer.

According to at least one embodiment, a portion of conductive balls in the adhesive layer is moved by pressing the flexible cable and is stacked on the passivation layer.

According to at least one embodiment, the PI portion has a thickness formed to be smaller than a thickness of the flexible cable.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a partially enlarged view of a base substrate according to an embodiment of the invention.

FIG. 2 is a coupling cross-sectional view of a portion A-A of a touch sensor module according to an embodiment of the invention for FIG. 1.

FIG. 3 is a coupling cross-sectional view of a portion B-B of the touch sensor module according to an embodiment of the invention for FIG. 1.

FIG. 4 is a cross-sectional view of a touch sensor module according to another second embodiment of the invention.

FIG. 5 is a plan view of an electrode pattern shown in FIG. 4 according to an embodiment of the invention.

FIGS. 6 to 8 are views illustrating a manufacturing method of a touch sensor module according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

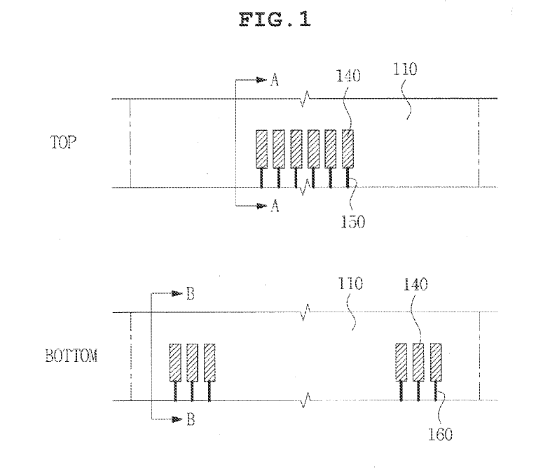

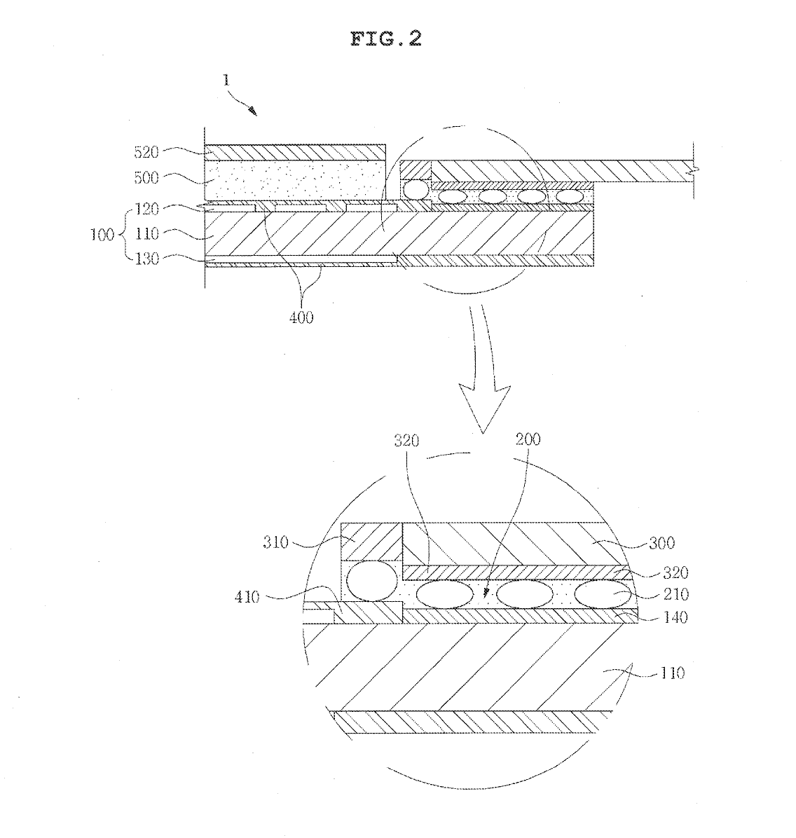

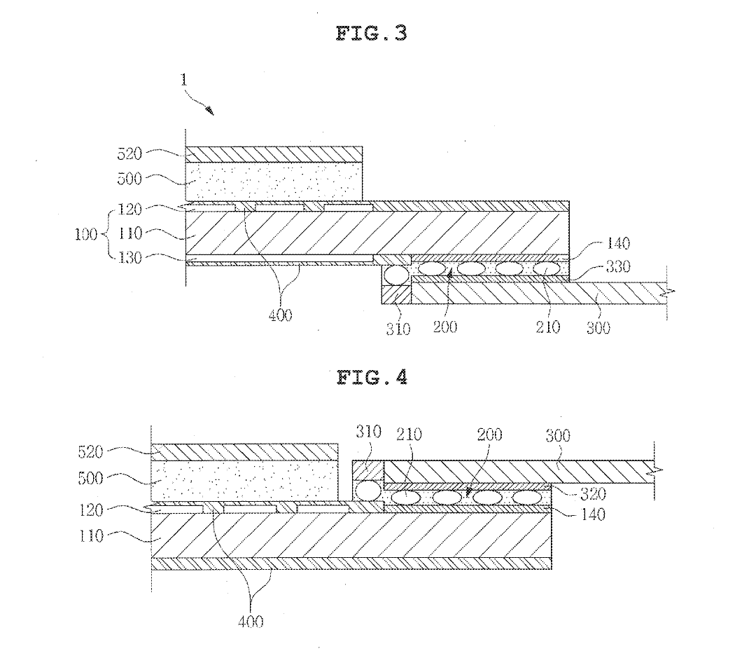

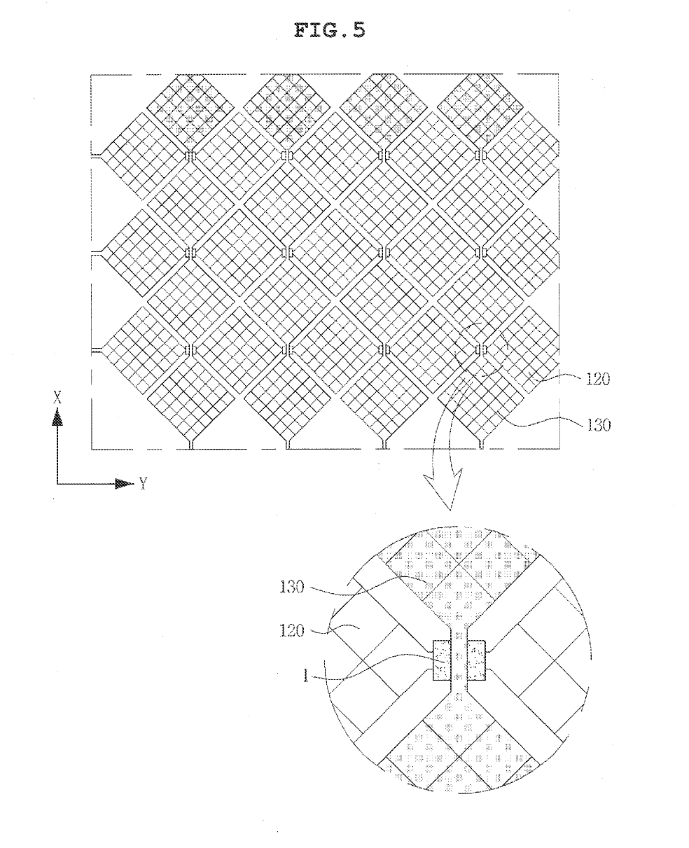

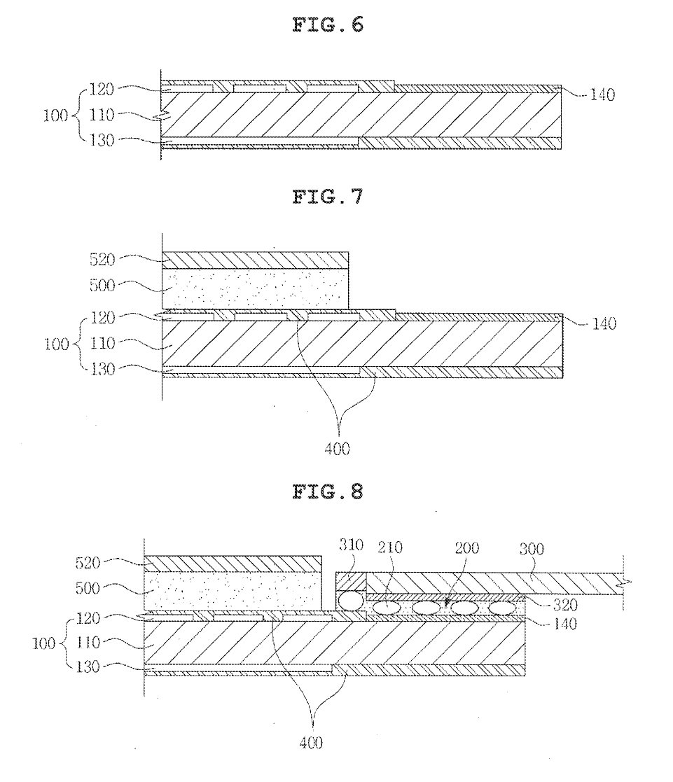

FIG. 1 is a partially enlarged view of a base substrate according to an embodiment of the invention, FIG. 2 is a coupling cross-sectional view of a portion A-A of a touch sensor module according to an embodiment of the invention for FIG. 1, FIG. 3 is a coupling cross-sectional view of a portion B-B of the touch sensor module according to an embodiment of the invention for FIG. 1, FIG. 4 is a cross-sectional view of a touch sensor module according to another embodiment of the invention, FIG. 5 is a plan view of an electrode pattern shown in FIG. 4 according to an embodiment of the invention, and FIGS. 6 to 8 are views illustrating a method of manufacturing a touch sensor module according to an embodiment of the invention.

As used herein, a term “touch” used throughout the present specification is to broadly be construed to mean that an input unit directly contacts with a contact reception surface and the input unit has come into close with the contact reception surface by a significant distance.

According to at least one embodiment, a touch sensor module 1 is configured to include a base substrate 110 having electrode patterns 120 and 130 formed thereon and including an electrode pad 140 transferring an electrical signal of the electrode patterns 120 and 130 to the outside, a passivation layer 400 coating surfaces of the electrode patterns 120 and 130, and a flexible cable 300 including an adhesive layer 200 formed to transfer the electrical signal by contacting one surface of the electrode pad 140. According to at least one embodiment, the passivation layer 400 is formed to not overlap with the electrode pad 140.

According to at least one embodiment, the touch sensor module 1 improves resistant-environment and resistant-water vapor transmission characteristics, which is to minimize, for example, infiltration of moisture into the touch sensor module 1. Thereby, operational reliability of the touch sensor module 1 is maintained even under high temperature and humidity environment, and user convenience and product application fields of the touch sensor module 1 is diversified.

According to at least one embodiment, the touch sensor 100 uses a resistive type touch sensor, a capacitive type touch sensor, and other various touch sensors 100, and a form and kind of the touch sensor 100 are not particularly limited. However, in the touch sensor module 1 according to at least one embodiment of the invention, a capacitive type touch sensor 100 having the electrode patterns 120 and 130 formed on both surfaces of the base substrate 110 will be described as an example.

With reference to FIGS. 1 to 3, the base substrate 110 serves to provide a region on which the electrode patterns 120 and 130 and electrode wirings 150 and 160 are to be formed. Here, the base substrate 110 is partitioned into an active region and a bezel region, where the active region, which is a portion in which the electrode patterns 120 and 130 are formed so as to recognize a touch of the input unit, is provided to the center of the base substrate 110 and the bezel region 330, which is a portion in which the electrode wirings 150 and 160 extended from the electrode patterns 120 and 130 are formed, is provided to the edge of the active region (see FIG. 1). According to at least one embodiment, the base substrate 110 needs to have support force capable of supporting the electrode patterns 120 and 130 and the electrode wirings 150 and 160 and transparency capable of allowing the user to recognize an image provided by the image display device (not shown). In consideration of the support force and the transparency, the base substrate 110 is made of for example, polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, as non-limiting examples. A first electrode pattern 120 to be described below is formed on one surface of the base substrate 110 and a second electrode pattern 130 is formed on the other surface thereof.

According to at least one embodiment, the electrode patterns 120 and 130, which serve to generate a signal at the time of the touch by the input unit to allow a controller to recognize a touch coordinate, are formed on the base substrate 110. According to at least one embodiment, an electrode pattern formed in an X axis direction of the base substrate 110 is referred to as a first electrode pattern 120, and an electrode pattern formed in an Y axis direction of the base substrate 110 is referred to as a second electrode pattern 130.

According to at least one embodiment, the electrode patterns 120 and 130 is formed by a plating process or a depositing process using a sputter. It is apparent to those skilled in the art that the electrode patterns 120 and 130 use a metal formed by exposing/developing a silver salt emulsion layer, and various kind of materials capable of forming a mesh pattern using the metal having conductivity is selected. According to at least one embodiment, the electrode patterns 120 and 130 are formed in all patterns known in the art, such as a diamond shaped pattern, a rectangular pattern, a triangular pattern, a circular pattern, as non-limiting examples.

According to at least one embodiment, the electrode wirings 150 and 160 connect the electrode patterns 120 and 130 described above and the flexible cable 300 to each other by the electrical signal. The electrode wirings 150 and 160 are formed on the base substrate 110 by various printing methods, such as a silk screen method, a gravure printing method, an inkjet printing method, as non-limiting examples (see FIG. 3). As a material of the electrode wirings 150 and 160, a copper (Cu) material, an aluminum (Al) material, a gold (Au) material, a silver (Ag) material, a titanium (Ti) material, a palladium (Pd) material, or a chromium (Cr) material is used. As the material of the electrode Wirings 150 and 160, silver (Ag) paste or organic silver having excellent electrical conductivity is used. However, the electrode wirings 150 and 160 are not limited to being made of the above-mentioned materials, but may be made of a conductive polymer, carbon black (including CNT), a metal oxide such as or ITO, or a low resistance metal material such metals, as non-limiting examples.

Depending on the type of touch sensor module 1, the electrode wirings 150 and 160 are connected to only one end of the electrode pattern 120. The electrode pad 140 electrically connected to the flexible cable 300 is disposed at end portions of the electrode wirings 150 and 160. In other words, the electrode pad 140 is formed on one portion of the electrode wirings 150 and 160 which is then electrically connected to the flexible cable 300.

According to at least one embodiment, the electrode pad 140 is connected to the electrode wirings 150 and 160 and is formed on the base substrate 110 (see FIG. 1). The electrode pad 140 is formed to not invade the flexible cable 300 and the active region of the base substrate 110, for example, a region recognizing the touch of the user. According to at least one embodiment, the electrode pad 140 is positioned at one side end portion of the base substrate 110 and is connected to the electrode wirings 150 and 160. The electrode pad 140 is formed so as to send electricity to the flexible cable 300 by contacting an adhesive layer 200. The electrode pad 140 is coupled to the adhesive layer 200 by pressing the flexible cable 300. In this case, the electrode pad 140 is coupled to the adhesive layer 200 in a stack direction of the base substrate 110. The electrode pad 140 is provided with a contact surface contact g conductive ball 210 of the adhesive layer 200. The contact surface is formed to be larger than a diameter of the conductive ball 210. A plurality of the electrode pads 140 are formed to be disposed at one side end portion of the base substrate 110. In this case, the electrode pads 140 are formed to be spaced apart from each other by a distance not causing electrical interference with an adjacent electrode pad.

According to at least One embodiment improves resistant-environment and resistant-water vapor transmission characteristics of the touch sensor module 1. A lift phenomenon of the conductive ball 210 and moisture infiltration is prevented by forming the passivation layer 400 to not be overlapped with the flexible cable 300 and the electrode pad 140.

According to at least one embodiment, the passivation layer 400 is formed by coating the surfaces of the electrode patterns 120 and 130. The passivation layer 400 is formed up to one side end portion of the electrode pad 140. Thus, the passivation layer 400 is formed to not be overlapped with the flexible cable 300. The passivation layer 400 prevents the moisture infiltration into the electrode patterns 120 and 130, the electrode wirings 150 and 160, and the electrode pad 140.

According to at least one embodiment, the passivation layer 400 is silicon dioxide (SiO₂), an insulation film made of silicon nitride (SiN), or a complex structure including thereof, or is made of a material, such as polyimide or epoxy, as non-limiting examples. The passivation layer 400 is formed to not be overlapped with the electrode pad 140. The passivation layer 400 is formed on one surface or both surfaces of the base substrate 110 on which the electrode patterns 120 and 130 are formed. The passivation layer 400 protects active surfaces of the electrode patterns 120 and 130 and prevents moisture infiltration thereinto. The passivation layer 400 serves as a catching jaw blocking a movement of the conductive ball 210 when the conductive hall 210 is applied with a predetermined pressing or more by a PI portion 310 described below.

According to at least one embodiment, a coating layer 500 is formed on the passivation layer 400 or the surfaces of the electrode patterns 120 and 130. The coating layer 500 adheres the passivation layer 400 to an image display device 520. Thus, the passivation layer 400 is adhered to one surface of the coating layer 500 and the image display device 520 is adhered to the other surface thereof. As an example, the coating layer 500 adheres the passivation layer 400 to the image display device 520. Therefore, the coating layer 500 is used so as to adhere different materials and devices to each other. A material of the coating layer 500 is made of an optical clear adhesive (OCA) or a double adhesive tape (DAT), but is not particularly limited thereto.

According to at least one embodiment, the flexible cable 300 is coupled to correspond to the electrode pad 140. The flexible cable 300 includes an adhesive layer 200 and a terminal portion 320. The flexible cable 300 is electrically connected to the electrode pad 140 and electrically connects between the electrode patterns 120 and 130 and a controlling unit (not shown). The terminal portion 320 contacts the conductive ball 210 and is electrically connected to thereto. The terminal portion 320 is formed at positions corresponding to a plurality of electrode pads 140. The terminal portion 320 is adhered to the electrode pad 140 by pressing the adhesive layer 200.

According to at least one embodiment, a lower end surface of the adhesive layer 200 is connected to the electrode pad 140 and an upper end surface of the adhesive layer 200 is coupled to the terminal portion 320. Thus, one surface of the conductive ball 210 in the adhesive layer 200 is adhered to the electrode pad 140 and the other surface thereof is adhered to the terminal portion 320 or 330. This is not to limit a form in which the adhesive layer 200 is adhered to the electrode pad 140 and the terminal portion 320.

According to at least one embodiment, the adhesive layer 200 is made of an anisotropic conductive film (ACF). In some cases, the adhesive layer 200 is made of a conductive material, such as an anisotropic conductive adhesive (ACA), as a non-limiting example.

According to at least one embodiment, the adhesive layer 200 contacts the electrode pad 140 and is electrically connected thereto. In the case in which the adhesive layer 200 is coupled to the electrode pad 140 by the pressing or is adhered to the electrode pad 140 by the pressing, the conductive ball 210 having conductivity is provided in the adhesive layer 200. The conductive ball 210 is adhered by the pressing during a coupling process of the electrode pad 140 and the terminal portion 320 and sends electricity in one direction. In this case, a portion of an adhesive solution flows out in the passivation layer 400 direction by pressing the adhesive layer 200. Thus, a portion of the conductive ball 210 is moved to the PI portion 310 due to the pressing.

According to at least one embodiment, the PI portion 310 prevents the passivation layer 400 the flexible cable 300 from being overlapped with each other. The PI portion 310 is formed integrally in the flexible cable 300 and is formed so as to be protruded in a direction of the electrode pattern 120 or 130 (see FIGS. 2 and 3). The PI portion 310 protects the conductive ball 210 from external impact and moisture and adjusts a pressed state of the conductive hall 210. The pressed state of the conductive ball 210 is adjusted by adjusting a thickness of the PI portion 310. The PI portion 310 prevents a lift phenomenon of the conductive ball 210 due to a step between the passivation layer 400 and the electrode pad 140. The PI portion 310 is the same material as the flexible cable 300.

According to at least one embodiment the PI portion 310 prevents the step from being generated at the time of the adhesion of the electrode pad 140 and the flexible cable 300. Thus, the PI portion 310 allows the conductive ball 210 to be applied with a predetermined pressure between the flexible cable 300 and the electrode pad 140. Thus, the PI portion 310 allows the flexible cable 300 and the electrode pad 140 to apply a uniform pressure to the adhesive layer 200.

According to at least one embodiment, the PI portion 310 allows the electrode patterns 120 and 130, the electrode pad 140, and the flexible cable 300 to be electrically connected. Thus, the PI portion 310 improves defect to an electric current to thereby secure reliability of a product.

According to at least one embodiment, the PI portion 310 has a protruded length formed to be longer than the diameter of the conductive ball 210 (see FIGS. 2 and 3). The PI portion 310 prevents an electrical short circuit at the time of the pressing of the electrode patterns 120 and 130 and the electrode pad 140. The PI portion 310 minimizes an assembly tolerance generated at the time of an assembly process of the flexible cable 300 and the electrode pad 140. The protruded length of the PI portion 310 is formed to be 500 μm or more taking into account the assembly tolerance of the conductive ball 210 and the diameter of the conductive ball 210.

Describing a touch sensor module 1 according to another embodiment of the invention with reference to FIGS. 4 and 5, a description of a structure and a material of the base substrate 110, the adhesive layer 200, the flexible cable 300, and the passivation layer 400, which are the same component as embodiment of the invention discussed above will be omitted, and electrode patterns 120 and 130 according to this embodiment of the invention will be described in detail.

According to at least one embodiment, the electrode patterns 120 and 130 are formed on one surface of the base substrate 110 and the touch sensor is formed by the electrode patterns 120 and 130 of a single layer. In a touch sensor module according to a modified example of the invention, a first electrode pattern 120 in a X axis direction and a second electrode pattern 130 in a Y axis direction intersected with the first electrode pattern 120 is formed on the base substrate 110 (see FIG. 5). In order to form the first electrode pattern 120 and the second electrode pattern 130 to be intersected with each other on a single surface, at a portion in which the first electrode pattern 120 and the second electrode pattern 130 are intersected with each other, an insulating pattern I is formed on any one electrode pattern and the other electrode pattern is electrically connected onto the insulating pattern I, such that an electrical connection between the first electrode pattern 120 and the second electrode pattern 130 which are intersected with each other is implemented. Although an intersection angle of the first electrode pattern 120 and the second electrode pattern 130 which are intersected with each other is shown to be vertical, the intersection angle is not particularly limited, and the first electrode pattern 120 and the second electrode pattern 130 is intersected with each other at an appropriate angle so as to derive coordinates of the X axis and the Y axis in order to extract a coordinate in a two-dimensional plane. Since the forming method and the material of the electrode patterns 120 and 130 are the same as those of the electrode patterns of the previously described embodiment of the invention as described above, a description thereof will be omitted.

Describing a manufacturing method of a touch sensor module according to another embodiment of the invention with reference to FIGS. 6 and 8, a description of a structure and a material of the base substrate 110, the adhesive layer 200, the flexible cable 300, and the passivation layer 400, which are the same component as the previously described embodiment of the invention will be omitted.

According to at least one embodiment, the method of manufacturing the touch sensor module according to the previously described embodiment of the invention includes a) preparing a base substrate having electrode patterns and an electrode pad formed thereon, b) forming a passivation layer coating up to one side end portion of the electrode patterns and the electrode pad, and c) connecting a flexible cable to the electrode pad using an adhesive layer.

According to at least one embodiment, in step a), the base substrate having the electrode patterns and the electrode pad formed thereon is prepared. Describing with reference to FIG. 6, passivation layers 400 are formed on surfaces of the electrode patterns. In this case, the passivation layer 400 coats up to one side end portion of the electrode pad. Thus, the passivation layer 400 is not overlapped with the flexible cable.

Next, describing with reference to FIG. 7, in step b), a coating layer 500 is formed on a surface of the passivation layer 400. The passivation layer 400 is adhered to one surface of the coating layer 500 and an image display device 520 is adhered to the other surface thereof. The coating layer 500 adheres the image display device 520 to the passivation layer 400 using an optical clear adhesive (OCA) or a double adhesive tape (DAT) (see FIG. 7). Describing with reference to FIG. 8, step c) is connecting the flexible cable 300 to the electrode pad 140 using the adhesive layer 200. The adhesive layer 200 is adhered to the electrode pad 140. In this case, pressing is performed so that the adhesive layer 200 is closely adhered to the electrode pad 140. An adhesive solution flows out from the adhesive layer 200 to the electrode patterns 120 and 130 due to the pressing. Thus, the conductive ball 210 of the adhesive layer 200 flows into the passivation layer 400. The conductive ball moves in a PI portion 310 direction or the conducive ball 210 disposed in the PI portion 310 in advance is overlapped with the passivation layer 400. The conductive ball 210 pressed by the PI portion 310 is cured to thereby prevent moisture. In addition, the conductive ball 210 disposed in the PI portion 310 is less pressed than the conductive ball 210 disposed between the electrode pad 140 and a terminal portion 320. A thickness and a length of the PI portion 310 are closely related to a pressed state of the conductive ball 210 and assembly tolerance.

For example, when the thickness of the PI portion 310 is thicker than that of the flexible cable 300, the conductive ball 210 disposed between the electrode pad 140 and the terminal portion 320 is electrically short-circuited. Thus, a lift phenomenon is caused by the conductive ball 210 disposed between the electrode pad 140 and the terminal portion 320.

According to at least one embodiment, in addition, the length of the PI portion 310 is formed to be shorter than a diameter of the conductive bail 210, an assembly error is caused by the conductive ball 210 disposed between the electrode pad 140 and a terminal portion 320 due to the assembly tolerance, thereby causing an electrical short circuit. Moreover, the conductive ball 210 moves in a direction of the electrode pattern 120 or 130, thereby causing the electrical short-circuit. By considering this, a protruded length of the PI portion 310 is formed to be 500 μm or more taking into account the assembly tolerance of the conductive ball 210 and the diameter of the conductive ball 210.

According to an embodiment of the invention, the disconnection and the poor contact between the electrode pad and the flexible cable (FPCB) is prevented by forming the passivation layer and the flexible cable to not be overlapped with each other.

According to at least one embodiment, in addition, the pressed degree of the conductive ball is controlled by forming the passivation layer and the flexible cable to not be overlapped with each other.

According to at least one embodiment, the electrical short circuit due to the lift phenomenon of the electrode pad and the flexible cable is prevented by forming the passivation layer and the flexible cable to not be overlapped with each other, thereby making it possible to secure reliability of the product.

According to at least one embodiment, in addition, the moisture infiltration into the electrode pad and the flexible cable are prevented by forming the passivation layer and the flexible cable so as not to be overlapped with each other.

According try at least one embodiment, in addition, the corrosion of the electrode pad and the flexible cable is stopped or delayed by forming the passivation layer and the flexible cable to not be overlapped with each other.

According to at least one embodiment, in addition, the infiltration of moisture and sweat into the touch sensor module in use is prevented by forming the passivation layer and the flexible cable to not be overlapped with each other.

According to at least one embodiment, in addition, the moisture infiltration into the flexible cable (FPCB) and the electrode pad is prevented without separately requiring an additional material from the outside by forming the passivation layer and the flexible cable to not be overlapped with each other.

According to at least one embodiment, in addition, the separate sealing process is not performed by forming the passivation layer and the flexible cable to not be overlapped with each other, thereby making it possible to reduce the processing time and increase production yield.

According to at least one embodiment, in addition, the touch sensor module having improved sealing and adhesion is provided by forming the passivation layer and the flexible cable to not be overlapped with each other.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor module, comprising:
a base substrate comprising an electrode pattern formed thereon and an electrode pad configured to transfer an electrical signal of the electrode pattern to the outside;
a passivation layer coating surfaces of the electrode patterns; and
a flexible cable comprising a terminal portion formed to correspond to the electrode pad and further comprising an adhesive layer disposed between the electrode pad and the terminal portion,
wherein the passivation layer is formed to not be overlapped with the terminal portion.

2. The touch sensor module as set forth in claim 1, further comprising:
a PI portion formed to be protruded in one side direction of the flexible cable and configured to prevent moisture and prevent the adhesive layer from being delaminated.

3. The touch sensor module as set forth in claim 2, wherein a portion of an adhesive solution of the adhesive layer is moved by pressing the flexible cable and is stacked on the passivation layer.

4. The touch sensor module as set forth in claim 2, wherein the adhesive layer is made of an anisotropic conductive film (ACF) or an anisotropic conductive adhesive (ACA).

5. The touch sensor module as set forth in claim 4, wherein a portion of conductive balls in the adhesive layer is moved by pressing the flexible cable and is stacked on the passivation layer.

6. The touch sensor module as set forth in claim 5, wherein the PI portion has a protruded length formed to be longer than a diameter of the conductive ball.

7. The touch sensor module as set forth in claim 6, wherein the protruded length of the PI portion is formed to be 500 μm or more taking into account assembly tolerance.

8. The touch sensor module as set forth in claim 5, wherein the PI portion comprises a thickness formed to be smaller than a thickness of the flexible cable.

9. A manufacturing method of a touch sensor module, the method comprising;
a) preparing a base substrate comprising electrode patterns and an electrode pad formed thereon;
b) forming a passivation layer coating up to one side end portion of the electrode pattern and the electrode pad; and
c) connecting a flexible cable to the electrode pad using an adhesive layer.

10. The method as set forth claim 9, wherein in step c) a PI portion protruded in one side direction of the flexible cable to thereby prevent moisture and prevent the adhesive layer from being delaminated is formed.

11. The method as set forth in claim 10, wherein the adhesive layer is made of an anisotropic conductive film (ACT) or an anisotropic conductive adhesive (ACA).

12. The method as set forth in claim 11, wherein the PI portion has a protruded length formed to be longer than a diameter of the conductive ball of the adhesive layer.

13. The method as set forth in claim 11, wherein a portion of conductive balls in the adhesive layer is moved by pressing the flexible cable and is stacked on the passivation layer.

14. The method as set forth in claim 11, wherein the PI portion comprises a thickness formed to be smaller than a thickness of the flexible cable.
